(19) United States
(12) Patent Application Publication
(10) Pub. No.: US 2018/0288701 A1
(43) Pub. Date: Oct. 4, 2018

(54) RE-SYNCHRONIZATION OF ELECTRONIC DEVICES OPERATING WITH EXTENDED DRX TIME PERIODS

(71) Applicant: Telefonaktiebolaget LM Ericsson (publ), Stockholm (SE)

(72) Inventors: Andreas Höglund, Solna (SE); Paul Schliwa-Bertling, Ljungsbro (SE); Oscar Ohlsson, Stockholm (SE)

(21) Appl. No.: 15/764,511

(22) PCT Filed: Oct. 4, 2016
(86) PCT No.: PCT/SE2016/050939

§ 371 Date: Mar. 29, 2018

Related U.S. Application Data
(60) Provisional application No. 62/238,942, filed on Oct. 8, 2015.

(51) Int. Cl. H04W 52/02; H04W 76/28

(52) U.S. Cl. CPC H04W 52/0216; H04W 68/005; H04W 76/28

(57) ABSTRACT

This disclosure relates to wireless communication. In one aspect, the technology described herein concerns a method performed by, or executed in, an electronic device such as a User Equipment (UE) operating with an extended DRX time period, or cycle. Re-synchronization parameter(s) is/are accessed. In response thereto, the re-synchronization parameter(s) is/are applied to synchronize a timer of the electronic device in accordance with the re-synchronization parameter(s). Aspects disclosed herein enable a UE-CN (i.e., Core Network) based solution which is timer based and which, also, allows for extending DRX time periods, or cycles, beyond the ordinary DRX time periods.

### TECHNICAL FIELD

This disclosure generally relates to wireless communication. More particularly, this disclosure relates to the usage of extended Discontinuous Reception (DRX) time periods, or DRX cycles, in wireless communication. Some embodiments disclosed herein propose the introduction of new messages (e.g., Non-Access Stratum (NAS) messages) that can be advantageously used for re-synchronization of electronic devices, such as User Equipment (UE), when the electronic devices operate with extended DRX time periods (a.k.a., extended DRX cycles), e.g. achieved in UE-CN co-ordination.

### BACKGROUND

In LTE Rel-13 (i.e, Long Term Evolution, Release 13) there is an ongoing work item (WI) on extended DRX time periods, or cycles, for UEs such as machine type communication (MTC) UEs. As used herein, an extended DRX time period (or, cycle) is used to mean a DRX time period (or, cycle) which is at least longer than an ordinary, or normal, DRX time period (or, cycle). That is, an extended DRX time period (or, cycle) is for example used to mean a DRX time period (or, cycle) which is at least longer than 2.56 seconds for E-UTRAN/LTE. The length of this ordinary, or normal, DRX time period, i.e. the length of the time the UE is (at least partially) powered down or “asleep” between reception periods, is typically quite short, of the order of a few seconds (e.g., approximately 10 seconds or so) at most. An extended DRX time period would be particularly advantageous for MTC devices, largely because it may keep down the frequency of paging monitoring. Hence, extended DRX time periods may allow for keeping down power consumption of the MTC devices, etcetera. In turn, the usage of extended DRX time periods may also allow for improving, i.e. lengthen, the MTC battery lifetimes.

### SUMMARY

It is in view of the above considerations and others that the various embodiments disclosed herein have been made.

The present disclosure recognizes that DRX cycle lengths are typically limited to e.g. 10.24 seconds by the wrap-around of the system frame number (SFN). Two different solutions could, e.g., be envisaged for extending DRX time periods beyond this:
1) a “UE-eNB (i.e., evolved NodeB)”-based solution which relies on extending the SFN range; or
2) a “UE-CN (i.e. Core Network)” based solution which is timer based.

In the first solution the SFN range must generally be extended which means that additional SFN bits must generally be included in system information (SI) broadcast. Furthermore, this may be seen as departing from the legacy procedure that the evolved NodeB (eNB) is rather unaware of the paging process (i.e., transparent).

Instead, embodiments proposed herein are based on a timer based solution. In other words, embodiments proposed herein are based on the above-mentioned second solution, which may rely on extended DRX cycles being negotiated between an electronic device (e.g., UE) and a CN node (e.g. the Mobility Management Entity (MME)). In this latter second solution a respective timer may be started in both entities (i.e., in the UE and in the CN node (e.g., MME)) and the CN node may only page the electronic device during a ‘time window’ when this timer expires. This solution would require less standard changes than the first one. A further advantage is that it would be transparent to the evolved NodeB (eNB), meaning that extended DRX time periods could be deployed even in networks where there exist legacy eNBs. The setup signaling and the initiation of the timer may be done over Non-Access Stratum (NAS) signaling.

This disclosure further recognizes that a timer based extended DRX solution may rely on the fact that the respective timers, a.k.a. paging timers, in the electronic device (e.g., UE) and in the CN node (e.g., MME) may be started at a common time instance, i.e. point in time. For the initial instance this can be negotiated and setup by a NAS Attach Request/Complete signaling, see e.g. FIG. 1. FIG. 1 shows the legacy NAS Attach procedure for registration onto the network, see e.g. the Technical Specification 3GPP TS 23.401.

In the example shown in FIG. 1, the MME may start the timer at an instance (i.e., point in time) when transmitting the Attach Accept message and the UE starts its timer at an instance of reception of that message (i.e., at NAS Attach Complete in FIG. 1). Due to, e.g., internal clock drift in the UE there will typically be a need to occasionally re-synchronize the UE and the MME.

The periodic ‘Tracking Area Update’ (TAU) is a procedure by which a UE is obliged to occasionally (e.g., with some configured periodicity) notify the MME in which tracking area it resides. This may, e.g., be done in order to facilitate paging. Since this procedure is generally performed by NAS signaling between the UE and the MME, this disclosure recognizes that this could be reused for re-synchronization. For example, the TAU update occurs every time the timer T3412 expires. However, the timer T3412 is reset and started with its initial value, when the UE goes from EMM-CONNECTED to EMM-IDLE, i.e. from the EMM-CONNECTED state to the EMM-IDLE state. Therefore, if data activity (e.g., uplink reporting periodicity) is more frequent than the TAU periodicity, T3412 will typically never expire and TAU can typically not be used for re-synchronization.

On the other hand, transactions related to user plane transfer include NAS Service Request, however, there is no NAS response (see, e.g., FIG. 2) and thus cannot generally be used for re-synchronization. FIG. 2 shows the legacy NAS Service Request for uplink/downlink (UL/DL) data transmission (see e.g. the Technical Specification 3GPP TS 23.401).

In view of the above, a general idea proposed by this disclosure is to introduce novel messages to be signaled between an electronic device (such as a UE) operating with an extended DRX time period and a CN node (such as a MME).

In one of its aspects, the technology presented herein therefore concerns a method performed by, or executed in, an electronic device operating with an extended discontinuous reception (DRX) time period. Re-synchronization parameter(s) are accessed. Also, in response to synchronization parameter(s) being accessed, the accessed re-synchronization parameter(s) are applied in order to synchronize a timer of the electronic device. In other words, the timer of the electronic device can be synchronized in accordance with the accessed re-synchronization parameter(s).

Accessing the re-synchronization parameter(s) may comprise receiving a message including the re-synchronization parameter(s). The method may further comprise reading the re-synchronization parameter(s) from the received message prior to applying the re-synchronization parameter(s).

Furthermore, receiving the message including the re-synchronization parameter(s) may comprise receiving a Non-Access Stratum (NAS) message from a Core Network node (CN node), the message including said re-synchronization parameter(s).

The CN node may for example be a Mobility Management Entity (MME).

The method may also comprise transmitting a message indicating that the electronic device requests re-synchronization parameter(s). In some embodiments, transmitting the message may comprise transmitting a NAS Service Request message to a CN node (e.g., a MME) indicating that the electronic device operates with the extended DRX time period and, also, that the electronic device requests re-synchronization parameter(s).

In some embodiments, the electronic device may be a User Equipment (UE).

Typically, the above-mentioned extended DRX time period has a length (e.g., in seconds) which is longer than an ordinary DRX time period.

In contrast, in the legacy procedure there is generally no need for re-synchronization, since there is no timer.

In another of its aspects, this disclosure concerns a method performed by, or executed in, a CN node for assisting in re-synchronizing an electronic device operating with a DRX time period. Re-synchronization parameter(s) are provided to the electronic device for enabling the electronic device to synchronize a timer of the electronic device in accordance with the re-synchronization parameter(s).

Prior to the providing of re-synchronization parameter(s) to the electronic device, the method may also comprise accessing information indicating that the electronic device operates with the extended DRX time period and, also, that the electronic device is in need of accessing re-synchronization parameter(s). Also, the method may comprise receiving a message from the electronic device indicating that the electronic device requests re-synchronization parameter(s). For example, a NAS Service Request message may be received from the electronic device, wherein said NAS Service Request message indicates that the electronic device operates with the extended DRX time period and, also, that the electronic device requests re-synchronization parameter(s).

The method may additionally comprise (e.g., in response to accessing said information indicating that the electronic device operates with the extended DRX time period and, also, that the electronic device is in need of accessing re-synchronization parameter(s) and prior to providing the re-synchronization parameter(s) to the electronic device) preparing re-synchronization parameter(s) that enable(s) the electronic device to synchronize the timer of the electronic device with the timer of the CN node.

In some embodiments, providing re-synchronization parameter(s) to the electronic device comprises transmitting a message including the re-synchronization parameter(s) to the electronic device. For example, transmitting the message including the re-synchronization parameter(s) may comprise transmitting a NAS message including said re-synchronization parameter(s). In some embodiments, the NAS message may optionally be appended to an already existing NAS message.

The CN node may for example be a MME.

Typically, the above-mentioned extended DRX time period has a length (e.g., in seconds) which is longer than an ordinary DRX time period.

In still another of its aspects, this disclosure concerns a computer program, comprising instructions which, when executed on at least one processor, cause the at least one processor to carry out the method(s) described hereinabove. A carrier comprising the computer program may also be provided. For example, the carrier may be one of an electronic signal, an optical signal, a radio signal, or a computer readable storage medium.

In yet another of its aspects, this disclosure concerns an electronic device configured to operate with an extended DRX time period. The electronic device comprises a processor and a memory. The memory comprises instructions executable by the processor whereby the electronic device is operative to: access re-synchronization parameter(s); and in response thereto apply the re-synchronization parameter(s) to synchronize a timer of the electronic device in accordance with the re-synchronization parameter(s).

The electronic device may further comprise a receiver configured to receive a message including the re-synchronization parameter(s).

Furthermore, the memory may comprise instructions executable by the processor whereby the electronic device is operative to read the re-synchronization parameter(s) from a received message prior to applying the re-synchronization parameter(s).

In some embodiments, the receiver may be configured to receive a NAS message from a CN node, the message including said re-synchronization parameter(s).

In some embodiments, the electronic device may further comprise a transmitter configured to transmit a message indicating that the electronic device requests re-synchronization parameter(s). For example, in some embodiments the transmitter is configured to transmit a NAS Service Request message to a CN node (e.g. a MME) indicating that the electronic device operates with the extended DRX time period and, also, that the electronic device requests re-synchronization parameter(s).

The electronic device may be a UE.

Also, the above-mentioned extended DRX time period may have a length which is longer than an ordinary DRX time period.

In yet another of its aspects, this disclosure concerns a CN node for assisting in re-synchronizing an electronic device that is configured to operate with an extended DRX time period. The CN node comprises a processor and a memory. The memory comprises instructions executable by the processor whereby the CN node is operative to provide re-synchronization parameter(s) to the electronic device for enabling the electronic device to synchronize a timer of the electronic device in accordance with the re-synchronization parameter(s).

The memory may further comprise instructions executable by the processor whereby the CN node is operative to (e.g., prior to the providing of re-synchronization parameter(s) to the electronic device) access information indicating that the electronic device operates with the extended DRX time period and, also, that the electronic device is in need of accessing re-synchronization parameter(s).

The CN node may comprise a receiver configured to receive a message from the electronic device indicating that the electronic device requests re-synchronization parameter(s). For example, the receiver may be configured to receive a NAS Service Request message from the electronic device indicating that the electronic device operates with the extended DRX time period and, also, that the electronic device requests re-synchronization parameter(s).

In some embodiments, the memory may also comprise instructions executable by the processor whereby the CN node is operative to (e.g., in response to accessing said information indicating that the electronic device operates with the extended DRX time period and, also, that the electronic device is in need of accessing re-synchronization parameter(s) and prior to providing the re-synchronization parameter(s) to the electronic device) prepare re-synchronization parameter(s) that enable(s) the electronic device to synchronize the timer of the electronic device with the timer of the CN node.

The CN node may also comprise a transmitter configured to transmit a message including the re-synchronization parameter(s) to the electronic device. For example, the transmitter may be configured to transmit a NAS message including said re-synchronization parameter(s).

The CN node may be a MME.

Typically, the above-mentioned extended DRX time period has a length (e.g., in seconds) which is longer than an ordinary DRX time period.

In yet a further of its aspects, this disclosure concerns a method performed in a wireless communication system. A CN node provides re-synchronization parameter(s) to an electronic device operating with an extended DRX time period for enabling the electronic device to synchronize a timer of the electronic device in accordance with the re-synchronization parameter(s). The electronic device accesses said re-synchronization parameter(s). In response thereto, the electronic device applies the accessed re-synchronization parameter(s) to synchronize the timer of the electronic device in accordance with the re-synchronization parameter(s).

In some embodiments, the CN node may transmit a NAS message including the re-synchronization parameter(s) to the electronic device. The electronic may receive said NAS message including the re-synchronization parameter(s).

The CN node may be a MME and the electronic device may be a UE.

As will be appreciated, some embodiments described herein propose the introduction of a novel and stand-alone NAS message for the purpose of resynchronization. For example, if or when a UE connects to a network to either transmit or receive data it may follow the NAS Service Request procedure (see FIG. 3). FIG. 3 shows the NAS Service Request coupled with the novel NAS re-synchronization signaling. Affected messages and processes are shown by the labels 1), 2), 3) and 4), respectively.

According to the example embodiment shown in FIG. 3, the MME receives the ‘NAS service request’ and discovers that the UE is operating in extended DRX and is in need of re-synchronization. This may trigger the MME to send a NAS re-synchronization message which is used by the UE to synchronize its DRX timer.

As will be recognized, e.g. by those skilled in the art, the MME discovers that the UE is operating in extended DRX and requires re-synchronization e.g. based on the contents of the ‘NAS service request’. This can either be done by including an explicit indication in the request or by checking the UE identity (e.g., S-TMSI) to the register of UEs in current use of extended DRX in the MME. The actual re-sync procedure may thereby be ensured to only be carried out for UEs requiring it and, as a consequence, not causing any additional overhead for legacy UEs.

The NAS re-synchronization procedure may cause some additional messages to be sent over the radio interface. However, since theses messages may be piggybacked with existing signaling, this does not necessarily impact the total number of roundtrips. Piggybacking, e.g., multiplexing of data units, is supported by both the Radio Link Control (RLC) layer and Media Access Control (MAC) layer in LTE.

Various embodiments described herein are advantageous in that these embodiments support, or otherwise enable, a UE-CN based solution for extending DRX time periods, or cycles, beyond the ordinary DRX time periods.

### BRIEF DESCRIPTION OF THE DRAWINGS

These and other aspects, features and advantages will be apparent and elucidated from the following description of various embodiments, reference being made to the accompanying drawings, in which:

FIG. 1 shows the legacy NAS Attach procedure for registration onto the network, see e.g. the Technical Specification 3GPP TS 23.401.

FIG. 2 shows the legacy NAS Service Request for uplink/downlink (UL/DL) data transmission, see e.g. the Technical Specification 3GPP TS 23.401.

FIG. 3 shows an example NAS Service Request coupled with novel NAS re-synchronization signaling.

FIG. 4 shows an example embodiment of a method performed by, or otherwise executed in, an electronic device such as a UE.

FIG. 5 illustrates a carrier comprising a computer program, in accordance with an embodiment;

FIG. 6 illustrates an example embodiment of an electronic device such as a UE;

FIG. 7 illustrates an example implementation of an electronic device such as a UE;

FIG. 8 shows an example embodiment of a method performed by, or otherwise executed by, an CN node such as a MME;

FIG. 9 illustrates a carrier comprising a computer program, in accordance with an embodiment;

FIG. 10 illustrates an example embodiment of a CN node such as a MME;

FIG. 11 illustrates an example implementation of a CN node such as a MME.

FIG. 12 illustrates another example implementation of an electronic device such as a UE; and

FIG. 13 illustrates another example implementation of a CN node such as a MME.

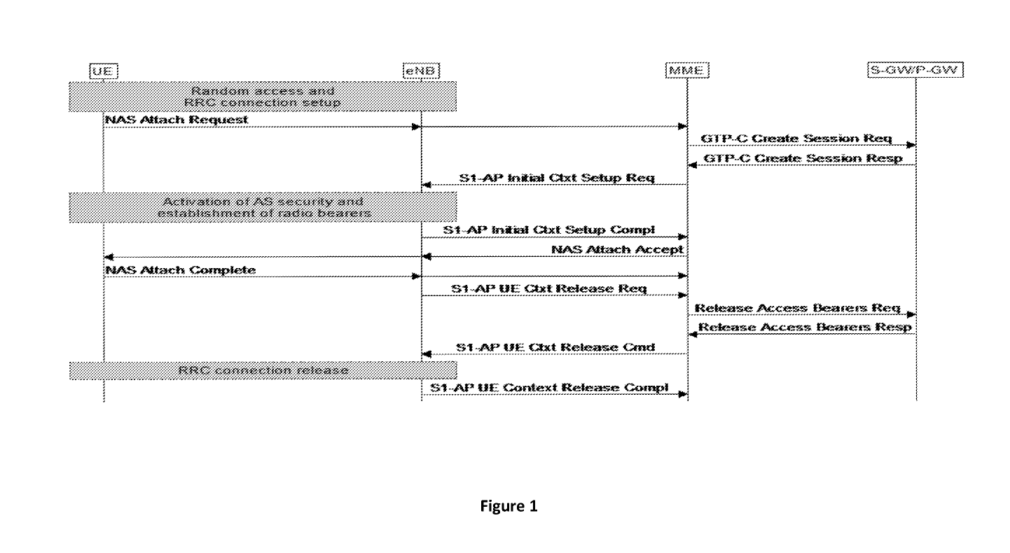

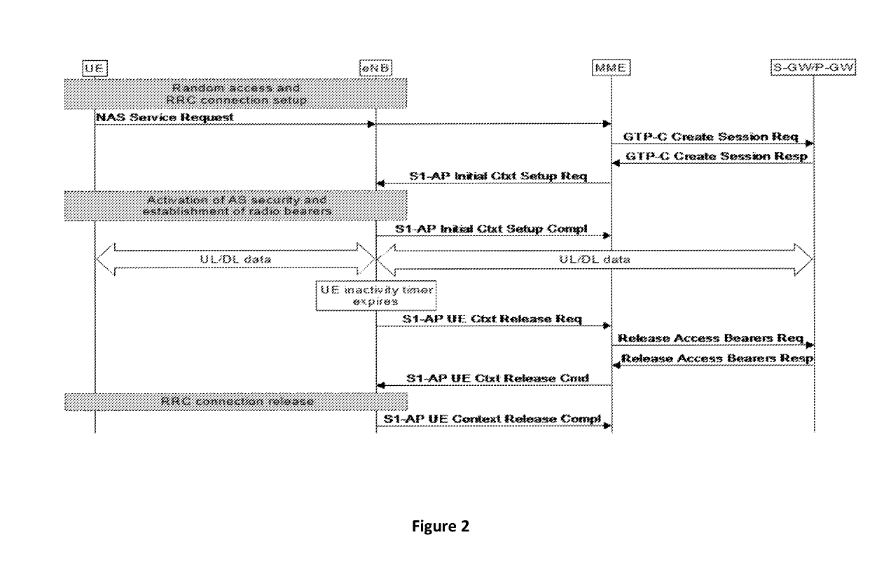

### DETAILED DESCRIPTION

The present technology will now be described more fully hereinafter. The technology may, however, be embodied in many different forms and should not be construed as limited to the embodiments set forth herein; rather, these embodiments are provided by way of example so that this disclosure will be thorough and complete, and will fully convey the scope of the technology to those persons skilled in the art. Like reference numbers refer to like elements or method steps throughout this description.

As described earlier, there is a need for a solution that enables an extension of DRX time periods beyond the ordinary DRX time periods. For example, there may also be a need to allow for an extension beyond the SFN periodicity. In other words, there is a need to enable for DRX time periods to have lengths (in seconds) that are longer than the ordinary DRX time periods.

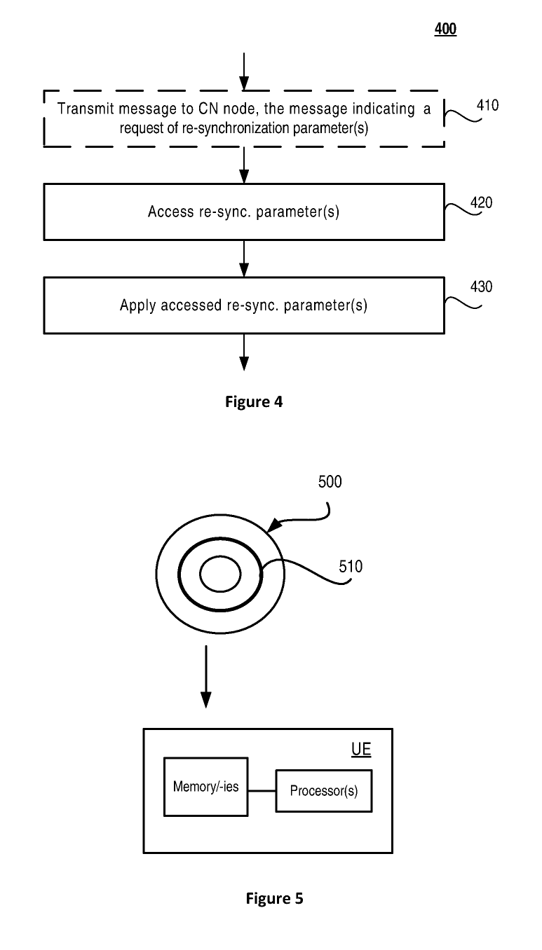

FIG. 4 illustrates a method 400 performed by, or executed in, an electronic device (e.g., a UE) operating with an extended DRX time period. The extended DRX time period may have a length (in seconds) which is typically longer than an ordinary DRX time period.

Action 410:

In some embodiments, a message indicating that the electronic device requests re-synchronization parameter(s) may be optionally transmitted, e.g. to a CN node such as the MME. For example, transmitting this message may advantageously comprise transmitting a NAS Service Request message to a CN node (e.g. the MME) indicating that the electronic device operates with the extended DRX time period and, also, that the electronic device requests re-synchronization parameter(s).

Action 420:

Re-synchronization parameter(s) is/are accessed. In some embodiments, the accessing of the re-synchronization parameter(s) comprises receiving a message including the re-synchronization parameter(s), e.g. from a remote device. In advantageous embodiments, receiving the message including the re-synchronization parameter(s) may comprise receiving a NAS message from a CN node such as the MME, the message including said re-synchronization parameter(s).

As used herein, the expression “re-synchronization parameter(s)” may be used to mean any parameter(s) that is/are used for re-synchronization of a timer of the electronic device (see also action 430 described in further detail hereinbelow). In some embodiments, the re-synchronization parameter(s) include(s) a timing parameter indicative of a timing, i.e. point in time (e.g., denoted t0). As such, resynchronization parameter(s) may include anything that enables the electronic device (e.g. UE) and the CN node (e.g. MME) to have a common understanding of a certain timing (or point in time), e.g. setting a new t0.

Action 430:

The accessed (e.g., received or otherwise obtained) re-synchronization parameter(s) is/are applied to synchronize a timer of the electronic device. In other words, the electronic device may synchronize its timer in on the basis of the accessed re-synchronization parameter(s). As will be appreciated, the re-synchronization parameter(s) may be read, or otherwise fetched, from a received message prior to the re-synchronization parameter(s) are applied.

With reference to FIG. 5, another embodiment will be briefly discussed. FIG. 5 shows an example of a computer-readable medium, in this example in the form of a data disc 500.

In one embodiment the data disc 500 is a magnetic data storage disc. The data disc 500 is configured to carry instructions 510 that can be loaded into a memory of an electronic device, e.g. UE as exemplified in FIG. 5. Upon execution of said instructions by a processor of the electronic device, the electronic device is caused to execute a method or procedure according to any one of the embodiments described herein e.g. in conjunction with FIG. 4. The data disc 500 is arranged to be connected to or within and read by a reading device (not shown), for loading the instructions into the processor. One such example of a reading device in combination with one (or several) data disc(s) 500 is a hard drive. It should be noted that the computer-readable medium can also be other mediums such as compact discs, digital video discs, flash memories or other memory technologies commonly used. In such an embodiment the data disc 500 is one type of a tangible computer-readable medium. The instructions may alternatively be downloaded to a computer data reading device, such as an electronic device capable of reading computer coded data on a computer-readable medium, by comprising the instructions in a computer-readable signal (not shown) which is transmitted via a wireless (or wired) interface (for example via the Internet) to the computer data reading device for loading the instructions into a processor of the electronic device. In such an embodiment, the computer-readable signal is one type of a non-tangible computer-readable medium.

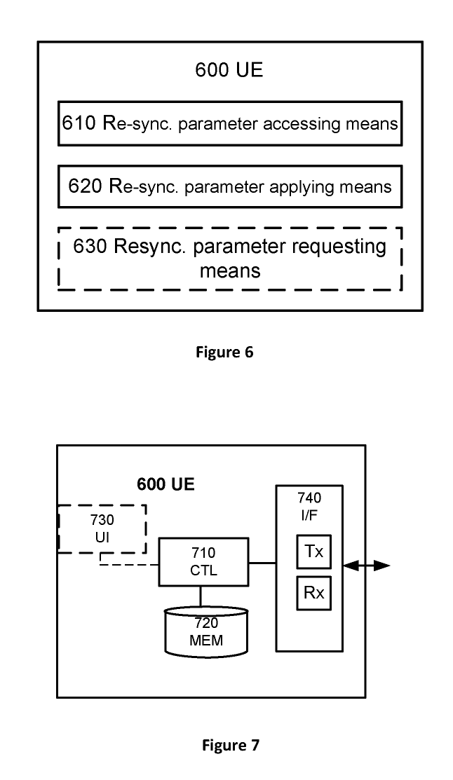

FIG. 6 illustrates an example embodiment of an electronic device 600, e.g. a UE, which is configured to operate with an extended DRX time period, or cycle.

The electronic device 600 may be adapted to perform, or otherwise execute, any of the methods described herein such as the methods(s) described with reference to FIG. 4. In this example embodiment, the electronic device 600 comprises means 610 adapted to access re-synchronization parameter(s). Also, means 620 adapted to apply the accessed re-synchronization parameter(s) to synchronize a timer of the electronic device in accordance with the re-synchronization parameter(s) are provided. In some embodiments, the means 610 are adapted to receive a message including the re-synchronization parameter(s). Also, the means 620 may be adapted to read the re-synchronization parameter(s) from the accessed (e.g., received) message prior to applying the re-synchronization parameter(s). In some embodiments, the means 610 may be adapted to receive a NAS message from a CN node, the message including said re-synchronization parameter(s). The CN node may be a MME. In some embodiments, the electronic device 600 may optionally also comprise means 630 adapted to transmit a message indicating that the electronic device requests re-synchronization parameter(s). For example, the means 630 may be adapted to transmit a NAS Service Request message to a CN node (e.g. a MME) indicating that the electronic device operates with the extended DRX time period and, also, that the electronic device requests re-synchronization parameter(s).

Turning now to FIG. 7, an example implementation of an electronic device 600 will be described in more detail. The electronic device 600 is configured to operate with an extended discontinuous DRX time period. The extended DRX time period may have a length (e.g., in seconds) which is longer than an ordinary DRX time period.

As can be seen in FIG. 7, the electronic device 600 comprises a processor 710; and a memory 720. A user interface (UI) 730 may also be optionally provided in order for a user of the electronic device 600 to operate and interact with the electronic device 600. Also, a communications interface 740, or a communications circuitry, may be provided in order to allow the electronic device 600 to communicate with other electronic devices 600 and/or other devices, e.g. via a network. To this end, the communications interface 740 may comprise a transmitter (Tx) and a receiver (Rx). Alternatively, the communications interface 740 may comprise a transceiver (Tx/Rx) combining both transmission and reception capabilities. The communications interface 740 may include a radio frequency (RF) interface allowing the electronic device 600 to communicate with electronic devices 600 and/or other devices through a radio frequency band through the use of different radio frequency technologies such as LTE (Long Term Evolution), WCDMA (Wideband Code Division Multiple Access), any other cellular network standardized by the 3rd Generation Partnership Project (3GPP), or any other wireless technology such as Wi-Fi, Bluetooth®, etcetera.

The memory 720 comprises instructions which are executable by the processor 710 whereby the electronic device 600 is operative to access re-synchronization parameter(s) and in response thereto apply the re-synchronization parameter(s) to synchronize a timer of the electronic device in accordance with the re-synchronization parameter(s).

A receiver (Rx) 740 may be configured to receive a message including the re-synchronization parameter(s).

Furthermore, the memory 720 may comprise instructions executable by the processor 710 whereby the electronic device 600 is operative to read the accessed re-synchronization parameter(s) from an accessed (e.g. received) message prior to applying the re-synchronization parameter(s).

For example, the receiver (Rx) 740 may be configured to receive a NAS message from a CN node, the message including said re-synchronization parameter(s).

Furthermore, a transmitter (Tx) 740 may be provided to optionally transmit a message indicating that the electronic device requests re-synchronization parameter(s). The transmitter (Tx) 740 may be configured to transmit a NAS Service Request message to a CN node (e.g. a MME) indicating that the electronic device operates with the extended DRX time period and, also, that the electronic device requests re-synchronization parameter(s).

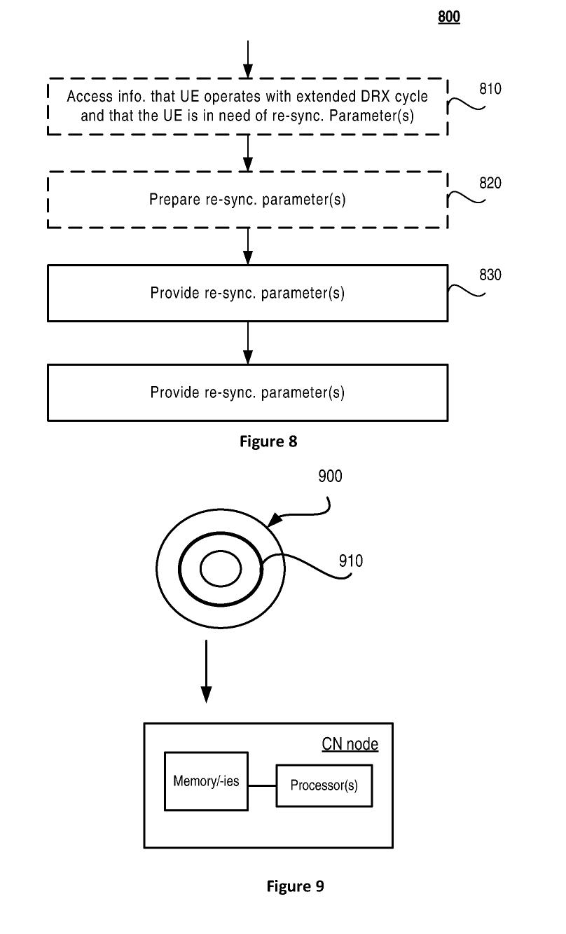

FIG. 8 illustrates a method 800 performed by, or executed in, a CN node (e.g., a MME) for assisting in re-synchronizing an electronic device operating with an extended DRX time period. The extended DRX time period may have a length (e.g., in seconds) which is typically longer than an ordinary DRX time period.

Action 810:

In advantageous embodiments, information indicating that the electronic device operates with the extended discontinuous reception, DRX, time period and, also, that the electronic device is in need of accessing re-synchronization parameter(s) may be accessed initially. In some embodiments, this action, or step, may comprise receiving a message from the electronic device indicating that the electronic device requests re-synchronization parameter(s). For example, in some embodiments a NAS Service Request message may be received from the electronic device. The NAS Service Request message may indicate that the electronic device operates with the extended DRX time period and, also, that the electronic device requests re-synchronization parameter(s).

Action 820:

For example, in response to accessing said information indicating that the electronic device operates with the extended DRX time period and, also, that the electronic device is in need of accessing re-synchronization parameter(s), the re-synchronization parameter(s) that enable(s) the electronic device to synchronize the timer of the electronic device with the timer of the CN node are prepared, or otherwise created.

Action 830:

Re-synchronization parameter(s) is/are provided to the electronic device for enabling the electronic device to synchronize a timer of the electronic device in accordance with the re-synchronization parameter(s). In some embodiments, the provision of re-synchronization parameter(s) to the electronic device comprises transmitting a message including the re-synchronization parameter(s) to the electronic device. For example, a NAS message including said re-synchronization parameter(s) may be transmitted.

With reference to FIG. 9, another embodiment will be briefly discussed. FIG. 9 shows an example of a computer-readable medium, in this example in the form of a data disc 900.

In one embodiment the data disc 900 is a magnetic data storage disc. The data disc 900 is configured to carry instructions 910 that can be loaded into a memory of an electronic device, e.g. a CN node. Upon execution of said instructions by a processor of the electronic device, the CN node is caused to execute a method or procedure according to any one of the embodiments described herein e.g. in conjunction with FIG. 8. The data disc 900 is arranged to be connected to or within and read by a reading device (not shown), for loading the instructions into the processor. One such example of a reading device in combination with one (or several) data disc(s) 900 is a hard drive. It should be noted that the computer-readable medium can also be other mediums such as compact discs, digital video discs, flash memories or other memory technologies commonly used. In such an embodiment the data disc 900 is one type of a tangible computer-readable medium. The instructions may alternatively be downloaded to a computer data reading device, such as an electronic device capable of reading computer coded data on a computer-readable medium, by comprising the instructions in a computer-readable signal (not shown) which is transmitted via a wireless (or wired) interface (for example via the Internet) to the computer data reading device for loading the instructions into a processor of the electronic device. In such an embodiment, the computer-readable signal is one type of a non-tangible computer-readable medium.

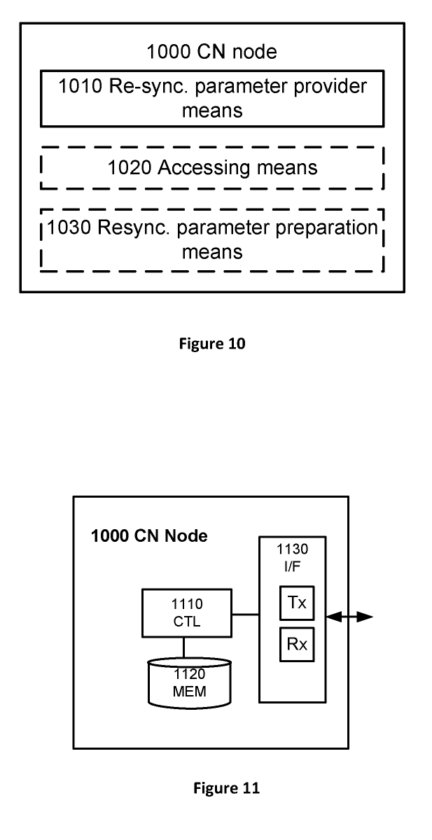

FIG. 10 illustrates an example embodiment of a CN node 1000, e.g. a MME, which is configured to assist in re-synchronizing an electronic device (e.g. a UE) operating with an extended DRX time period, or cycle. Again, the extended DRX time period typically has a length which is longer than an ordinary DRX time period.

The CN node 1000 may be adapted to perform, or otherwise execute, any of the methods described herein such as the methods(s) described with reference to FIG. 8. In this example embodiment, the CN node 1000 comprises means 1010 adapted to provide re-synchronization parameter(s) to the electronic device for enabling the electronic device to synchronize a timer of the electronic device in accordance with the re-synchronization parameter(s). Also, the CN node 1010 may comprise means 1020 adapted to access information indicating that the electronic device operates with the extended DRX time period and, also, that the electronic device is in need of accessing re-synchronization parameter(s). In some embodiments, the means 1020 are adapted to receive a message from the electronic device indicating that the electronic device requests re-synchronization parameter(s). For example, the means 1020 may be adapted to receive a NAS Service Request message from the electronic device indicating that the electronic device operates with the extended DRX time period and, also, that the electronic device requests re-synchronization parameter(s). Furthermore, the CN node 1000 may additionally comprise means 1030 adapted to prepare re-synchronization parameter(s) that enable(s) the electronic device to synchronize the timer of the electronic device with the timer of the CN node. For example, the means 1030 may be adapted to prepare the re-synchronization parameter(s) in response to accessing said information indicating that the electronic device operates with the extended DRX time period and, also, that the electronic device is in need of accessing re-synchronization parameter(s) and prior to providing the re-synchronization parameter(s) to the electronic device.

In advantageous embodiments, the means 1010 are configured to transmit a message including the re-synchronization parameter(s) to the electronic device. For example, the means 1010 may be adapted to transmit a NAS message including said re-synchronization parameter(s).

Turning now to FIG. 11, an example implementation of a CN node 1000 such as a MME will be described in more detail. The electronic device 600 is configured to assist in re-synchronizing an electronic device (e.g. a UE) operating with an extended DRX time period, or cycle. Again, the extended DRX time period typically has a length which is longer than an ordinary DRX time period.

As can be seen in FIG. 11, the electronic device 1000 comprises a processor 1110 and a memory 1120. Also, a communications interface 1130, or a communications circuitry, may be provided in order to allow the CN node to communicate with other nodes and/or other electronic devices, e.g. via a network. To this end, the communications interface 1130 may comprise a transmitter (Tx) and a receiver (Rx). Alternatively, the communications interface 1130 may comprise a transceiver (Tx/Rx) combining both transmission and reception capabilities. The communications interface 1130 may include a radio frequency (RF) interface allowing the CN node to communicate with, nodes, electronic devices and/or other devices through a radio frequency band through the use of different radio frequency technologies such as LTE (Long Term Evolution), WCDMA (Wideband Code Division Multiple Access), any other cellular network standardized by the 3rd Generation Partnership Project (3GPP), or any other wireless technology such as Wi-Fi, Bluetooth®, etcetera.

The memory 1120 comprises instructions executable by the processor 1110 whereby the CN node 1000 is operative to provide re-synchronization parameter(s) to the electronic device for enabling the electronic device to synchronize a timer of the electronic device in accordance with the re-synchronization parameter(s).

Furthermore, the memory 1120 may optionally also comprise instructions executable by the processor 1110 whereby the CN node 1000 is operative to, prior to the providing of re-synchronization parameter(s) to the electronic device: access information indicating that the electronic device operates with the extended discontinuous reception, DRX, time period and, also, that the electronic device is in need of accessing re-synchronization parameter(s).

Still further, the receiver (Rx) 1130 may be configured to receive a message from the electronic device indicating that the electronic device requests re-synchronization parameter(s). For instance, the receiver (Rx) 1130 may be configured to receive a NAS Service Request message from the electronic device indicating that the electronic device operates with the extended DRX time period and, also, that the electronic device requests re-synchronization parameter(s).

In some embodiments, the memory 1120 may comprise instructions executable by the processor 1110 whereby the CN node 1000 is operative to, in response to accessing said information indicating that the electronic device operates with the extended DRX time period and, also, that the electronic device is in need of accessing re-synchronization parameter(s) and prior to providing the re-synchronization parameter(s) to the electronic device: prepare re-synchronization parameter(s) that enable(s) the electronic device to synchronize the timer of the electronic device with the timer of the CN node.

Moreover, the transmitter (Tx) 1130 may be configured to transmit a message including the re-synchronization parameter(s) to the electronic device. For instance, the transmitter (Tx) 1130 may be configured to transmit a NAS message including said re-synchronization parameter(s).

As will be appreciated, other implementations that those described above may alternatively be provided.

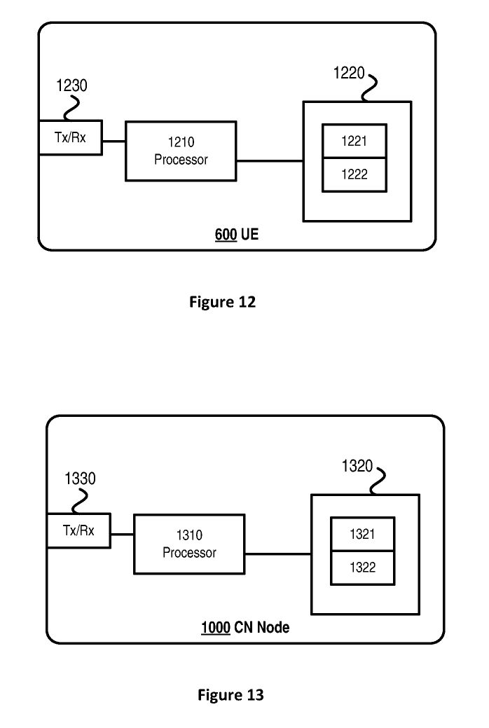

For example, FIG. 12 schematically illustrates an alternative implementation of an electronic device, e.g. an UE. The electronic device, here exemplified by UE 600, may comprise a processor 1210, various modules 1220, and a communications interface 1230. The communications interface 1230 may comprise a transmitter (Tx) and/or a receiver (Rx). The electronic device 600 shown in FIG. 12 may be adapted to perform, or otherwise execute, the method described herein with reference to FIG. 4. In this example implementation, the electronic device 600 comprises a re-sync parameter accessing module 1221 for accessing re-synchronization parameter(s), i.e. one or several re-synchronization parameters. Also, a re-sync module 1222 is provided for subsequently applying the re-synchronization parameter(s) that was/were accessed by means of the re-sync parameter accessing module 1221. Accordingly, the re-sync module 1222 may be configured to apply, or otherwise utilize, the accessed re-synchronization parameter(s) to synchronize a timer of the electronic device in accordance with the re-synchronization parameter(s).

In some embodiments, a receiver (Rx) 1230 may be configured to receive a message including the re-synchronization parameter(s). Furthermore, the re-sync parameter accessing module 1221 may be configured to read the re-synchronization parameter(s) from the received message prior to the re-sync module 1222 applying the re-synchronization parameter(s). In some embodiments, the receiver (Rx) 1230 may be adapted to receive a NAS message from a CN node, the message including said re-synchronization parameter(s). For example, the CN node may be a MME.

In some embodiments, the electronic device 600 may also comprise a transmitter (Tx) 1230 configured to transmit a message indicating that the electronic device requests re-synchronization parameter(s). For example, the transmitter (Tx) 1230 may be adapted to transmit a NAS Service Request message to a CN node (e.g. a MME) indicating that the electronic device operates with the extended DRX time period and, also, that the electronic device requests re-synchronization parameter(s).

FIG. 13 schematically illustrates an alternative implementation of a CN node, e.g. a MME. The CN node may comprise a processor 1210, various modules 1220, and a communications interface 1230. The communications interface 1230 may comprise a transmitter (Tx) and/or a receiver (Rx). The CN node 1000 shown in FIG. 13 may be adapted to perform, or otherwise execute, the method described herein with reference to FIG. 8. In this example implementation, the CN node 1000 comprises a re-sync parameter provision module 1321 for providing re-synchronization parameter(s) to the electronic device for enabling the electronic device to synchronize a timer of the electronic device in accordance with the re-synchronization parameter(s). Also, the CN node 1000 may comprise a re-sync need module 1322 for access information indicating that the electronic device operates with the extended DRX time period and, also, that the electronic device is in need of accessing re-synchronization parameter(s).

In some embodiments, a receiver (Rx) 1330 is configured to receive a message from the electronic device indicating that the electronic device requests re-synchronization parameter(s). For example, the receiver (Rx) 1330 may be configured to receive a NAS Service Request message from the electronic device indicating that the electronic device operates with the extended DRX time period and, also, that the electronic device requests re-synchronization parameter(s).

Furthermore, the CN node 1000 may additionally comprise re-sync parameter preparation module 1323 for preparing re-synchronization parameter(s) that enable(s) the electronic device to synchronize the timer of the electronic device with the timer of the CN node. For example, the re-sync parameter preparation module 1323 may be configured to prepare the re-synchronization parameter(s) in response to accessing said information indicating that the electronic device operates with the extended DRX time period and, also, that the electronic device is in need of accessing re-synchronization parameter(s) and prior to providing the re-synchronization parameter(s) to the electronic device.

In advantageous embodiments, a transmitter (Tx) 1330 is configured to transmit a message including the re-synchronization parameter(s) to the electronic device. For example, the transmitter (Tx) may be configured to transmit a NAS message including said re-synchronization parameter(s).

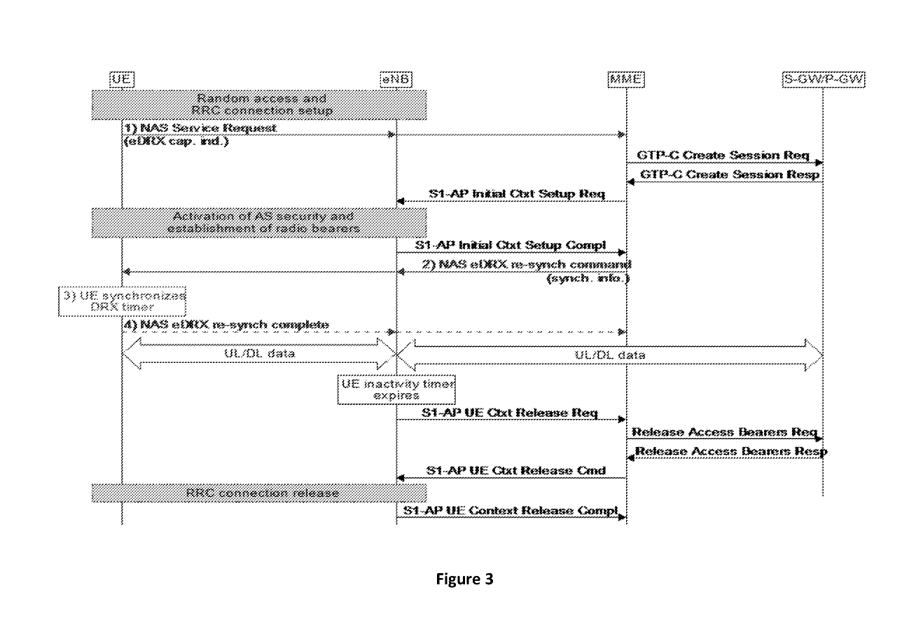

As will be recognized upon reading this disclosure, this disclosure thus inter alia proposes methods which may be implemented in a UE and an MME. Returning now to FIG. 3, a description of some of the steps that may be performed in the UE and MME in accordance with some embodiments will be described, or repeated (using the signaling diagram in FIG. 3 as an exemplary reference). Some modifications for the steps are possible without departing from embodiments described in this disclosure.
1. A UE with pending uplink (UL) or downlink (DL) data may trigger the NAS Service Request procedure to request service from the network.
   The NAS Service Request may be sent from the UE to the MME. The message may be transmitted in the last step of the RRC Connection Setup and then forwarded by the eNB to the MME. As part of the forwarding the eNB may also include the UE identity (typically an S-TMSI) that the eNB learnt during the RRC Connection Setup.
   In an alternative example, the UE may include an explicit indication in the NAS Service Request to indicate to the MME that it is operating in extended DRX and requires DRX re-synchronization.
   The NAS Service Request may cause a transition of the UE from ECM-IDLE to ECM-CONNECTED. This may involve a transfer of the UE context to the eNB, establishment of the radio bearers and activation of AS security. However, as these steps are not directly related to the method described here the details are omitted in order not to obscure the presentation of the embodiments of this disclosure.
2. Upon receipt of the NAS Service Request message and the associated UE identity, the MME may first determine if the UE is operating in extended DRX and is need of DRX re-synchronization. This information may for example be stored as part of the UE context maintained by the MME. If the MME determines that re-synchronization is required, a NAS re-synchronization request may be sent to the UE. The request may include synchronization information that allows the UE to synchronize its DRX timer with the MME. This could for example be the current elapsed time of the DRX timer in the MME.
   As mentioned in step 1, in an alternative embodiment the UE may include an explicit indication in the NAS Service Request to indicate to the MME that it is operating in extended DRX and requires DRX re-synchronization.
   The NAS re-synchronization request is sent from the MME to UE via the eNB.

Although not indicated in the figure, the forwarded NAS message may potentially be piggybacked with other UE data sent over the radio interface. While this would be up the eNB scheduler, the MME would have the ability to influence the eNBs decision to some extent by adjusting the time the NAS message is transmitted to the eNB.
3. The UE may receive the NAS re-synchronization request, extract the synchronization data and update its DRX timer. For example, if the data comprises the elapsed time of the DRX timer in the MME, the update may be done by replacing the corresponding value in the UE with the received value. After this step the DRX timer in the UE and MME may be synchronized.
   Optionally, the UE may need to make adjustments to account for timing differences caused by transmission and processing delays when it updates the DRX timer.
4. The UE may send a NAS re-synchronization response to the MME to acknowledge that it has synchronized its DRX timer. This step is not essential and is thus optional.
   After the DRX timer has been synchronized and an acknowledgement potentially been transmitted, the UE may proceeds with the UL and/or DL data transfer just as in a normal NAS Service Request scenario.
   According to some embodiments described herein, a dedicated NAS procedure may thus be introduced for synchronizing a DRX timer in the UE and MME. This may allow a timer based extended DRX solution to be used also by e.g. low-cost UEs. These UEs, i.e. low-cost UEs, typically suffer from clock drift which would otherwise make it difficult to maintain long running timers.

### ABBREVIATIONS

### Abbreviation Explanation

AS Access Stratum
DRX Discontinuous reception
eNB Evolved Node B
EPS Evolved Packet System
E-UTRAN Evolved Universal Terrestrial Radio Access Network
GPRS General Packet Radio System
LTE Long Term Evolution
MME Mobile Management Entity
NAS Non Access Stratum
RRC Radio Resource Control
SAE System Architecture Evolution
SFN System Frame Number
S-TMSI SAE Temporary Mobile Subscriber Identity

### Selected Example Embodiments

The technology disclosed herein thus encompasses without limitation the following non-limiting numbered example embodiments (NEEs):

NEE1. A method performed by, or executed in, an electronic device operating with an extended discontinuous reception, DRX, time period, the method comprising:
accessing re-synchronization parameter(s); and in response thereto
applying the re-synchronization parameter(s) to synchronize a timer of the electronic device in accordance with the re-synchronization parameter(s).

NEE2. The method of NEE1, wherein accessing the re-synchronization parameter(s) comprises:
receiving a message including the re-synchronization parameter(s).

NEE3. The method of NEE2, comprising:
reading the re-synchronization parameter(s) from the received message prior to applying the re-synchronization parameter(s).

NEE4. The method of NEE2 or NEE3, wherein receiving the message including the re-synchronization parameter(s) comprises:
receiving a Non-Access Stratum, NAS, message from a Core Network node, CN node, the message including said re-synchronization parameter(s).

NEE5. The method of NEE4, wherein the CN node is a Mobility Management Entity, MME.

NEE6. The method of any one of NEE2-NEE5, further comprising:
transmitting a message indicating that the electronic device requests re-synchronization parameter(s).

NEE7. The method of NEE6, wherein transmitting the message comprises:
transmitting a NAS Service Request message to a CN node (e.g. a MME) indicating that the electronic device operates with the extended DRX time period and, also, that the electronic device requests re-synchronization parameter(s).

NEE8. The method of any one of NEE1-NEE7, wherein the electronic device is a User Equipment, UE.

NEE9. The method of any one of NEE1-NEE8, wherein the extended DRX time period has a length which is longer than an ordinary DRX time period.

NEE10. A method performed by, or executed in, a Core Network, CN, node for assisting in re-synchronizing an electronic device operating with an extended discontinuous reception, DRX, time period, the method comprising:
providing re-synchronization parameter(s) to the electronic device for enabling the electronic device to synchronize a timer of the electronic device in accordance with the re-synchronization parameter(s).

NEE11. The method of NEE10, comprising, prior to the providing of re-synchronization parameter(s) to the electronic device:
accessing information indicating that the electronic device operates with the extended discontinuous reception, DRX, time period and, also, that the electronic device is in need of accessing re-synchronization parameter(s).

NEE12. The method of NEE11, comprising:
receiving a message from the electronic device indicating that the electronic device requests re-synchronization parameter(s).

NEE13. The method of NEE12, comprising:
receiving a NAS Service Request message from the electronic device indicating that the electronic device operates with the extended DRX time period and, also, that the electronic device requests re-synchronization parameter(s).

NEE14. The method of any one of NEE10-13, comprising, in response to accessing said information indicating that the electronic device operates with the extended DRX time period and, also, that the electronic device is in need of accessing re-synchronization parameter(s) and prior to providing the re-synchronization parameter(s) to the electronic device:
preparing re-synchronization parameter(s) that enable(s) the electronic device to synchronize the timer of the electronic device with the timer of the CN node.

NEE15. The method of any of the NEE10-14, wherein providing re-synchronization parameter(s) to the electronic device comprises:
transmitting a message including the re-synchronization parameter(s) to the electronic device.

NEE16. The method of NEE15, wherein transmitting the message including the re-synchronization parameter(s) comprises:
transmitting a NAS message including said re-synchronization parameter(s).

NEE17. The method of any one of NEE10-16, wherein the CN node is a Mobility Management Entity, MME.

NEE18. The method any one of NEE10-NEE17, wherein the extended DRX time period has a length which is longer than an ordinary DRX time period.

NEE19. Computer program, comprising instructions which, when executed on at least one processor, cause the at least one processor to carry out the method according to any one of NEE1-18.

NEE20. A carrier comprising the computer program according to NEE19, wherein the carrier is one of an electronic signal, an optical signal, a radio signal, or a computer readable storage medium.

NEE21. An electronic device configured to operate with an extended discontinuous reception, DRX, time period, the electronic device comprising:
a processor; and
a memory comprising instructions executable by the processor whereby the electronic device is operative to:
   access re-synchronization parameter(s); and in response thereto
   apply the re-synchronization parameter(s) to synchronize a timer of the electronic device in accordance with the re-synchronization parameter(s).

NEE22. The electronic device of NEE21, comprising a receiver configured to receive a message including the re-synchronization parameter(s).

NEE23. The electronic device of NEE22, wherein the memory comprises instructions executable by the processor whereby the electronic device is operative to read the re-synchronization parameter(s) from a received message prior to applying the re-synchronization parameter(s).

NEE24. The electronic device of NEE22 or NEE23, wherein the receiver is configured to receive a Non-Access Stratum, NAS, message from a Core Network node, CN node, the message including said re-synchronization parameter(s).

NEE25. The electronic device of any one of NEE22-24, further comprising a transmitter configured to transmit a message indicating that the electronic device requests re-synchronization parameter(s).

NEE26. The electronic device of NEE25, wherein the transmitter is configured to transmit a NAS Service Request message to a CN node (e.g. a MME) indicating that the electronic device operates with the extended DRX time period and, also, that the electronic device requests re-synchronization parameter(s).

NEE27. The electronic device of any one of NEE21-26, wherein the electronic device is a User Equipment, UE.

NEE28. The electronic device of any one of NEE21-NEE27, wherein the extended DRX time period has a length which is longer than an ordinary DRX time period.

NEE29. A Core Network, CN, node for assisting in re-synchronizing an electronic device that is configured to operate with an extended discontinuous reception, DRX, time period, the CN node comprising:
a processor; and
a memory comprising instructions executable by the processor whereby the CN node is operative to:
   provide re-synchronization parameter(s) to the electronic device for enabling the electronic device to synchronize a timer of the electronic device in accordance with the re-synchronization parameter(s).

NEE30. The CN node of NEE29, wherein the memory comprises instructions executable by the processor whereby the CN node is operative to, prior to the providing of re-synchronization parameter(s) to the electronic device:
access information indicating that the electronic device operates with the extended discontinuous reception, DRX, time period and, also, that the electronic device is in need of accessing re-synchronization parameter(s).

NEE31. The CN node of NEE30, comprising a receiver configured to receive a message from the electronic device indicating that the electronic device requests re-synchronization parameter(s).

NEE32. The CN node of NEE31, wherein the receiver is configured to receive a NAS Service Request message from the electronic device indicating that the electronic device operates with the extended DRX time period and, also, that the electronic device requests re-synchronization parameter(s).

NEE33. The CN node of any one of NEE29-32, wherein the memory comprises instructions executable by the processor whereby the CN node is operative to, in response to accessing said information indicating that the electronic device operates with the extended DRX time period and, also, that the electronic device is in need of accessing re-synchronization parameter(s) and prior to providing the re-synchronization parameter(s) to the electronic device:
prepare re-synchronization parameter(s) that enable(s) the electronic device to synchronize the timer of the electronic device with the timer of the CN node.

NEE34. The CN node of any of the NEE29-33, comprising a transmitter configured to transmit a message including the re-synchronization parameter(s) to the electronic device.

NEE35. The CN node of NEE34, wherein the transmitter is configured to transmit a NAS message including said re-synchronization parameter(s).

NEE36. The CN node of any one of NEE29-35, wherein the CN node is a Mobility Management Entity, MME.

NEE37. The CN node any one of NEE29-NEE36, wherein the extended DRX time period has a length which is longer than an ordinary DRX time period.

NEE38. A method performed in a wireless communication system, the method comprising:
a Core Network, CN, node providing re-synchronization parameter(s) to an electronic device operating with an extended discontinuous reception, DRX, time period for enabling the electronic device to synchronize a timer of the electronic device in accordance with the re-synchronization parameter(s); and
the electronic device accessing said re-synchronization parameter(s); and in response thereto
the electronic device applying the accessed re-synchronization parameter(s) to synchronize the timer of the electronic device in accordance with the re-synchronization parameter(s).

NEE39. The method of NEE38, comprising:
the CN node transmitting a Non-Access Stratum, NAS, message including the re-synchronization parameter(s) to the electronic device; and
the electronic receiving said NAS message including the re-synchronization parameter(s).

NEE40. The method of NEE38 or NEE39, wherein the CN node is a Mobility Management Entity, MME, and wherein the electronic device is a User Equipment, UE.

Modifications and other variants of the described embodiments will come to mind to one skilled in the art having benefit of the teachings presented in the foregoing description and associated drawings. Therefore, it is to be understood that the embodiments are not limited to the specific example embodiments disclosed and that modifications and other variants are intended to be included within the scope of this disclosure. Although specific terms may be employed herein, they are used in a generic and descriptive sense only and not for purposes of limitation.

1. A method performed by an electronic device operating with an extended discontinuous reception, DRX, time period, the method comprising:
accessing at least one re-synchronization parameter; and in response thereto
applying the at least one re-synchronization parameter to synchronize a timer of the electronic device in accordance with the at least one re-synchronization parameter.

2. The method according to claim 1, wherein accessing the at least one re-synchronization parameter comprises:
receiving a message including the at least one re-synchronization parameter.

3. The method according to claim 2, wherein receiving the message including the at least one re-synchronization parameter comprises:
receiving a Non-Access Stratum, NAS, message from a Core Network node, CN node, the message including said at least one re-synchronization parameter.

4. The method according to claim 2, further comprising:
transmitting a message indicating that the electronic device requests at least one re-synchronization parameter.

5. The method according to claim 4, wherein transmitting the message comprises:
transmitting a NAS Service Request message to a CN node indicating that the electronic device operates with the extended DRX time period and, also, that the electronic device requests at least one re-synchronization parameter.

6. A method performed by a Core Network, CN, node for assisting in re-synchronizing an electronic device operating with an extended discontinuous reception, DRX, time period, the method comprising:
providing at least one re-synchronization parameter to the electronic device for enabling the electronic device to synchronize a timer of the electronic device in accordance with the at least one re-synchronization parameter.

7. The method according to claim 6, comprising, prior to the providing of the at least one re-synchronization parameters to the electronic device:
accessing information indicating that the electronic device operates with the extended DRX time period and, also, that the electronic device is in need of accessing at least one re-synchronization parameter.

8. The method according to claim 7, comprising:
receiving a message from the electronic device indicating that the electronic device requests at least one re-synchronization parameter.

9. The method according to claim 8, comprising:
receiving a NAS Service Request message from the electronic device indicating that the electronic device operates with the extended DRX time period and, also, that the electronic device requests at least one re-synchronization parameters.

10. The method of claim 6, comprising, in response to accessing said information indicating that the electronic device operates with the extended DRX time period and, also, that the electronic device is in need of accessing at least one re-synchronization parameter and prior to providing the at least one re-synchronization parameter to the electronic device:
preparing at least one re-synchronization parameter that enables the electronic device to synchronize the timer of the electronic device with the timer of the CN node.

11. The method according to claim 6, wherein providing the at least one re-synchronization parameter to the electronic device comprises:
transmitting a message including the at least one re-synchronization parameter to the electronic device.

12. The method according to claim 11, wherein transmitting the message including the at least one re-synchronization parameter comprises:
transmitting a NAS message including said at least one re-synchronization parameter.

13. (canceled)

14. (canceled)

15. An electronic device configured to operate with an extended discontinuous reception, DRX, time period, the electronic device comprising:
a processor; and
a memory comprising instructions executable by the processor whereby the electronic device is operative to:
access at least one re-synchronization parameter; and in response thereto
apply the at least one re-synchronization parameter to synchronize a timer of the electronic device in accordance with the at least one re-synchronization parameter.

16. The electronic device according to claim 15, comprising a receiver configured to receive a message including the at least one re-synchronization parameter.

17. (canceled)

18. The electronic device according to claim 16, further comprising a transmitter configured to transmit a message indicating that the electronic device requests at least one re-synchronization parameter.

19. (canceled)

20. (canceled)

21. A Core Network, CN, node for assisting in re-synchronizing an electronic device that is configured to operate with an extended discontinuous reception, DRX, time period, the CN node comprising:
a processor; and
a memory comprising instructions executable by the processor whereby the CN node is operative to:
provide at least one re-synchronization parameter to the electronic device for enabling the electronic device to synchronize a timer of the electronic device in accordance with the at least one re-synchronization parameter.

22. The CN node according to claim 21, wherein the memory comprises instructions executable by the processor whereby the CN node is operative to, prior to the providing of the at least one re-synchronization parameter to the electronic device:
access information indicating that the electronic device operates with the extended discontinuous reception, DRX, time period and, also, that the electronic device is in need of accessing at least one re-synchronization parameter.

23. The CN node according to claim 22, comprising a receiver configured to receive a message from the electronic device indicating that the electronic device requests at least one re-synchronization parameter.

24. (canceled)

25. The CN node according to claim 24, wherein the memory comprises instructions executable by the processor whereby the CN node is operative to, in response to accessing said information indicating that the electronic device operates with the extended DRX time period and, also, that the electronic device is in need of accessing at least one re-synchronization parameter and prior to providing the at least one re-synchronization parameter to the electronic device:
prepare the at least one re-synchronization parameter that enables the electronic device to synchronize the timer of the electronic device with the timer of the CN node.

26. The CN node according to claim 21, comprising a transmitter configured to transmit a message including the at least one re-synchronization parameter to the electronic device.

27. (canceled)

28. (canceled)
